(19) United States
(12) Patent Application Publication
(10) Pub. No.: US 2006/0062873 A1
(43) Pub. Date: Mar. 23, 2006

(54) Curds for processed and imitation cheese, cheese products produced therefrom, novel intermediate products and methods of making same

(76) Inventors: Jeng-Jung Yee, Green Bay, WI (US); Randall L. Brandsma, Green Bay, WI (US); Lawrence I. Bell, Green Bay, WI (US); Michelle M. Malone, Green Bay, WI (US); Franco X, Milani, Green Bay, WI (US)

Correspondence Address: BRINKS HOFER GILSON & LIONE, P.O. BOX 10395, CHICAGO, IL, 60610, US

(21) Appl. No.: 11/226,866

(22) Filed: Sep. 13, 2005

Related U.S. Application Data
(60) Provisional application No. 60/609,606, filed on Sep. 13, 2004.

(51) Int. Cl. A23C 9/12

(52) U.S. Cl. 426/36

(57) ABSTRACT

Methods of making novel cheese curds and cheese products comprise the steps of providing a fluid milk protein source containing casein; mixing a milk coagulating enzyme into the fluid milk protein source; allowing the milk coagulating enzyme to react with the casein for a time sufficient for the fluid milk protein source to form coagulum while at a pH of 5.6 or above; heating the coagulum containing the enzyme treated casein to a temperature of at least 135° F., more preferably at least 150° F., while the fluid milk protein source is at a pH of 5.6 or above, for a time sufficient to cause syneresis of the coagulum and to form curds; and separating the curds from liquid remaining from the curd formation. In another embodiment, the milk coagulating enzyme is allowed to react with the casein for at least three hours while at a temperature at which a coagulum does not form; after which the fluid milk protein source containing the enzyme treated casein is heated to at least 135° F., for a time sufficient to cause the casein to form curds. The curds from either embodiment may be mixed with additional ingredients to make the cheese products, including processed and imitation cheese. A composition consisting essentially of a fluid milk protein source containing casein and milk coagulating enzyme in the form of a coagulum at a temperature of at least about 160° F., as well as ground curds having a weight average particle size of about 1.5 mm or less, are novel.

### REFERENCE TO EARLIER FILED APPLICATION

The present application claims the benefit of the filing date under 35 U.S.C. § 119(e) of Provisional U.S. Patent Application Ser. No. 60/609,606, filed Sep. 13, 2004, which is hereby incorporated by reference in its entirety.

### BACKGROUND OF THE INVENTION

The present invention relates to cheese curds for processed, imitation and other cheese products, cheese products produced therefrom, novel intermediate products and methods of making these items. In particular, the invention relates to the use of a high-temperature step that quickly causes liquid to separate from milk-coagulating-enzyme-treated casein in a fluid milk protein source.

Processed cheese has become a staple of the food industry. It is also a commodity, meaning that there are many suppliers of processed cheese. As a result, the price charged for processed cheese has a great impact on a supplier's share of the market. Thus processed cheese manufacturers are under constant pressure to reduce their costs. On the other hand, government regulations regarding the ingredients that can be used, and the desire for functional qualities such as taste, firmness, mouth feel and meltability, constrain efforts to reduce costs. In addition to the quality perceived by the consumer, functional qualities are also important in the manufacturing process.

One of the costs associated with making cheese curd, and hence a cost of making processed cheese made from such curd, is the capital equipment and operational cost in converting milk to cheese curd. Typical curd and cheese production processes require long holding times in large vats, especially while milk is being coagulated and the coagulated milk is gradually heated to effect syneresis, the expulsion of water and whey proteins from the cut coagulum. If the length of time that it took to make cheese curd could be reduced, the capital and operational costs could be reduced as well.

Another way to reduce cost is to use a low cost source of processed cheese ingredients, particularly protein and milkfat. For example, when there is an excess of milk, the milk is converted to nonfat dry milk and stored. Nonfat dry milk has the advantage of being very stable over time. Another milk protein source is rennet casein. Rennet casein is manufactured by rennet coagulation of skim milk along with subsequent gradual heating of the resulting curds/whey mixture to approximately 115-135° F., after which the whey is separated and the curds are washed with water to remove most of the lactose and residual whey proteins. After further curd/liquid separation, the curds are sized-reduced and dried, forming the finished rennet casein powder. This powder is insoluble in water and must be hydrated by a variety of methods to become useful in processed or imitation cheese manufacture. Since rennet casein is typically made from fresh skim milk at a normal pH of 6.6-6.7, the protein is quite functional when properly re-hydrated. There are, however, significant difficulties with the use of rennet casein in cheese products due to the variability and slowness of the re-hydration phase, in addition to noticeable off-flavors and odors in products manufactured from the re-hydrated powder.

Another problem associated with the manufacture of processed cheese is variations in the finished product due to the variations in the cheese used to make the product. In traditional cheese, containing rennet and a starter culture, the cheese ages and gets softer over time. Thus, the age of the cheese when it is used to make processed cheese has an effect on the firmness of the processed cheese. This makes it complicated to produce a uniform quality processed cheese while juggling plant schedules and the use of different stocks of raw material as they come into inventory, because the age and the softness of the raw material cheese changes over time.

Hence, there is still a need for a processed cheese that is less expensive, but still has good firmness and melt properties, and a process for making such a processed cheese. It would be particularly advantageous if a processed American-type cheese with good firmness and melt properties could be made at a reduced cost.

### BRIEF SUMMARY OF THE INVENTION

It was realized by the present inventors that conventional cheese making processes are often designed to optimize the activity of bacterial starter cultures. Hence, holding times and process temperatures are chosen which favor the bacterial fermentation of lactose to lactic acid, and which keep the bacteria alive so that such activity can continue on after the cheese is made and stored. It was also realized that cheese curds used to make processed cheese do not need to have any residual starter culture activity. As a result, the process for making cheese curds can be optimized around the activity of the milk coagulating enzyme, and process steps and temperatures can otherwise be modified to optimize the process of making curds for use in processed or imitation cheese products. As a result, a method has been developed for rapid and economical production of curds which contain highly functional casein for use in processed, imitation and other cheese products.

In a first aspect, the invention is a method of making cheese curds comprising the steps of: providing a fluid milk protein source containing casein; mixing a milk coagulating enzyme into the fluid milk protein source; allowing the milk coagulating enzyme to react with the casein for a time sufficient for the fluid milk protein source to form coagulum while at a pH of 5.6 or above; heating the coagulum containing the enzyme treated casein to a temperature of at least 150° F. while the fluid milk protein source is at a pH of 5.6 or above, for a time sufficient to cause syneresis of the coagulum and to form curds; and separating the curds from liquid remaining from the curd formation.

In a second aspect, the invention is a method of making a cheese product comprising the steps of: providing a fluid milk protein source containing casein, mixing a milk coagulating enzyme into the fluid milk protein source, allowing the milk coagulating enzyme to react with the casein for a time sufficient for the fluid milk protein source to form coagulum while at a pH of 5.6 or above; heating the coagulum containing the enzyme treated casein to a temperature of at least 150° F. while the fluid milk protein source is at a pH of 5.6 or above, for a time sufficient to cause syneresis of the coagulum and to form curds; separating the curds from liquid remaining from the curd formation; and mixing the curds with additional ingredients to make the cheese product.

In another aspect, the invention is a method of making cheese curds comprising the steps of: providing a fluid milk protein source containing casein; mixing a milk coagulating enzyme into the fluid milk protein source; allowing the milk coagulating enzyme to react with the casein for at least three hours while at a temperature at which a coagulum does not form; heating the fluid milk protein source containing the enzyme treated casein to a temperature of at least 135° F. for a time sufficient to cause the casein to form curds; and separating the curds from liquid remaining from the curd formation.

In yet another aspect, the invention is method of making cheese curds comprising the steps of: providing milk containing casein and having a solids content of between about 7% and about 25%; adjusting the pH of the milk to between about 5.8 and about 6.4; mixing a milk coagulating enzyme into the milk in a cheese making vat; allowing the milk coagulating enzyme to react with the casein for a time sufficient to cause a coagulum to form in the cheese making vat; cutting the coagulum while in the cheese making vat, said cutting occurring not more than 10 minutes after the milk coagulating enzyme is mixed with the milk; heating and stirring the cut coagulum in the cheese making vat to a temperature of at least 135° F. for a time sufficient to cause syneresis and the coagulum to form curds; and separating the curds from whey resulting from the curd formation process; the heating occurring over a period of not greater than 20 minutes, the duration of the heating period being measured from the time beginning when the cut coagulum begins to be stirred and its temperature is elevated, and ending when the whey starts to be separated.

In other aspects, the invention includes products made by the above processes, as well as novel intermediate products. For example, in one aspect, the invention is ground cheese curds having a weight average particle size of about 1.5 mm or less.

In another aspect, the invention is a composition consisting essentially of a fluid milk protein source containing casein and milk coagulating enzyme in the form of a coagulum at a temperature of at least about 160° F.

In another aspect, the invention is a cheese product having a composition and texture like that of an American-type cheese, made with a milk coagulating enzyme which has become predominantly deactivated during the make process, and including an acidifying agent other than lactic acid which provides the product with a pH of between about 4.9 and about 5.6.

In still another aspect, the invention is a method of making processed cheese comprising the steps of providing skim milk curds; grinding the skim milk curds; pretreating the ground skim milk curds with an emulsifying agent to form pretreated ground skim curds; combining the pretreated ground skim curds with additional ingredients; and cooking the pretreated ground skim curds and additional ingredients to make processed cheese.

In another aspect, the invention is a method of making a processed cheese product comprising the steps of: providing a fluid milk protein source containing casein; allowing the milk coagulating enzyme to react with the casein for a time sufficient for the fluid milk protein source to form coagulum while at a pH of 5.6 or above; heating the coagulum containing the enzyme treated casein to a temperature of at least 135° F. while the fluid milk protein source is at a pH of 5.6 or above, for a time sufficient to cause syneresis of the coagulum and to form curds; separating the curds from liquid remaining from the curd formation; and mixing the curds with additional ingredients to make the processed cheese product wherein the curds are either 1) used to make the processed cheese within 24 hours of being separated or 2) mixed with an acidifying agent and stored for at least 24 hours before being used to make the processed cheese.

In another aspect, the invention is a method of heating a fluid containing a coagulum of casein proteins wherein the fluid is heated at a rate of at least 10° F./sec. and to a temperature of at least 135° F. at least in part by direct injection of steam into the fluid while the fluid is continuously flowing.

A significant advantage of the curds of the present invention is that they can be utilized in normal processed cheese and imitation cheese manufacturing systems without the re-hydration difficulties normally encountered with use of rennet casein powders. In addition, the flavor and odor of finished cheese products made with the preferred skim curds are superior to such products made with re-hydrated rennet casein powders.

Another advantage of the preferred embodiment of the invention is that cheese curds can be made in a very short amount of time, thus reducing the cost of the cheese curds from capital equipment and operational cost perspectives. In addition, curds made by the preferred methods of the present invention give processed cheese an increased firmness compared to processed cheese made from conventional cheese curds. The curds can be used in a variety of cheese products. They can be made in such a short amount of time that it can be made as needed for processed cheese production.

These and other advantages of the invention will be most easily understood in light of the attached drawings and detailed description.

### BRIEF DESCRIPTION OF SEVERAL VIEWS OF THE DRAWINGS

FIG. 1 is a flow chart showing a first embodiment of a method of the present invention, making curds from skim milk.

FIG. 2 is a flow chart showing treatment of curds made from skim milk preparatory to their use in making processed cheese.

FIG. 3 is a flow chart showing processed cheese production according to two different embodiments of the invention.

FIG. 4 is a flow chart showing another embodiment of a method of the present invention, also making curds from skim milk, using low temperature renneting

FIG. 5 is a flow chart showing a third embodiment of a method of the present invention, making curds from whole milk.

### DETAILED DESCRIPTION OF THE INVENTION AND PREFERRED EMBODIMENTS

In the following passages, different aspects of the invention are defined in more detail. Each aspect so defined may be combined with any other aspect or aspects unless clearly indicated to the contrary. In particular any feature indicated as being preferred or advantageous may be combined with any other feature or features indicated as being preferred or advantageous

### DEFINITION OF TERMS

Unless indicated otherwise, percentages given for components in a composition are percentages by weight of the composition.

In the conventional manufacture of cheese, milk is processed to produce a semi-solid mass called “cheese curd” (or “curds”) and a liquid (whey). The curds contain casein, a small amount of lactose, most of the butterfat, minerals, and water. The whey contains whey proteins, most of the lactose, some of the butterfat, minerals, and water. The curds may be worked (e.g., stirred) and/or combined with certain flavor and taste producing ingredients, and/or ripened using bacteria to produce different varieties of “natural cheese”. With that background, the following definitions are given to explain terms used in describing and claiming the present invention.

“Milk” means the lacteal secretion obtained by the milking of one or more females of a mammalian species, such as cow, sheep, goat, water buffalo, or camel. Broadly speaking, such milk is comprised of casein (a phospho-protein), soluble (whey) proteins, lactose, minerals, butterfat (milkfat), and water. The amount of these constituents in the milk may be adjusted by the addition of, or the removal of all or a portion of, any of these constituents. The term “milk” includes lacteal secretion whose content has been adjusted.

Milk obtained by milking one or more cows is referred to as “cows' milk”. Cows' milk whose composition has not been adjusted is referred to herein as “whole milk”. It is comprised of casein, whey proteins, lactose, minerals, butterfat (milkfat), and water. The composition of “cows' milk” can be adjusted by the removal of a portion of or all of any of the constituents of whole milk, or by adding thereto additional amounts of such constituents. The term “skim milk” is applied to cows' milk from which sufficient milkfat has been removed to reduce its milkfat content to less than 0.5 percent by weight. The term “lowfat milk” (or “part-skim milk”) is applied to cows' milk from which sufficient milkfat has been removed to reduce its milkfat content to the range from about 0.5 to about 2.0 percent by weight.

The additional constituents are generally added to cows' milk in the form of cream, concentrated milk, dry whole milk, skim milk, or nonfat dry milk. “Cream” means the liquid, separated from cows' milk, having a high butterfat content, generally from about 18 to 40 percent by weight. “Concentrated milk” is the liquid obtained by partial removal of water from the whole milk. Generally, the milkfat (butterfat) content of concentrated milk is not less than 7.5 weight percent and the milk solids content is not less than 25.5 weight percent. “Dry whole milk” is whole milk having a reduced amount of water. It generally contains not more than five percent by weight of moisture on a milk solids not fat basis. “Nonfat dry milk” is the product obtained by the removal of water only from skim milk. Generally, its water content is not more than five weight percent and its milkfat content is not more than 1.5 weight percent.

Thus, the term “cows' milk” includes, among others, whole milk, low fat milk (part-skim milk), skim milk, reconstituted milk, recombined milk, and whole milk whose content has been adjusted.

The term “whey proteins” means milk proteins that generally do not precipitate in conventional cheese making processes. The primary whey proteins are lactalbumins and lactoglobulins. Other whey proteins that are present in significantly smaller concentrations include bovine serum albumin, euglobulin, pseudoglobulin, and immunoglobulins.

The term “fluid milk protein source” means a liquid which contains one or more proteins commonly found in milk, such as casein and whey proteins.

“Milk coagulating enzyme” means those enzymes that are capable of coagulating milk, including protease. The most common milk coagulating enzyme is calf rennet. Milk coagulating enzymes also include porcine rennet, microbial rennet, and rennet from fungal and vegetable sources. Included within the group of microbial rennet is fermentation derived chymosin. The milk coagulating enzyme reacts with the casein to cleave the protein and convert kappa-casein to para-casein. From literature, it appears that when 60-80% of the kappa-casein has been hydrolyzed, the casein micelle begin to aggregate and collapse together, initially forming a coagulum. As the coagulation process continues, any fat globules in the liquid are trapped within the protein matrix and curds are formed.

“Unrenneted casein” refers to casein which has not been subjected to action of milk coagulating enzymes.

“Conventional cheese” as used herein means a cheese made by the traditional method of coagulating milk, cutting the coagulated milk to form discrete curds, stirring and gradually heating the curds, draining off the whey, and collecting or pressing the curds. Milk from many different mammals may be used to make cheese, though cow's milk is the most common milk for cheese used to make processed cheese. Cow's milk contains whey proteins and casein at a weight ratio of about 1:4 whey proteins to casein. The conventional process for making natural cheese recovers the casein from the milk. Whey proteins dissolved in the whey are mostly discharged during the whey drainage step. The ratio of whey proteins to casein is between about 1:150 and about 1:40 for conventional cheese. For example, Cheddar cheese contains about 0.3% whey proteins. The ratio of whey proteins to casein is about 1:100 in typical Cheddar cheese, the most common conventional cheese. Cheddar cheese contains about 23% to about 26% protein by weight. Conventional cheese is often categorized by its age. Within 0 to 24 hours after the whey is drained, the material is often referred to as fresh curd. The curds are pressed and fused together to become cheese. Young cheese is often categorized as cheese that has been aged either 1-7 days, 1-2 weeks or 2 weeks to 1 month. Medium cheese is often categorized as aged 1-3 months or 3-6 months. Aged cheese is usually older than 6 months.

“American-type cheese” as used herein means the group of conventional cheeses including Cheddar, washed curd, Colby, stirred curd cheese and Monterey Jack. All must contain at least 50% fat in dry matter (FDM). Modifications in the historic process for making Cheddar cheese led to the development of the other three varieties. Washed curd cheese is prepared as Cheddar through the milling stage, when the curds are covered with cold water for 5 to 30 minutes. Washing increases moisture to a maximum of 42%. Stirred curd cheese has practically the same composition as Cheddar but has a more open texture and shorter (less elastic) body. It is manufactured as Cheddar except that agitation of cooked curd particles is used to promote whey drainage, and the Cheddaring and milling steps are eliminated. Colby cheese and Monterey Jack cheese are manufactured the same way as stirred curd except that cold water is added to wash and cool the curds when most of the whey has been drained away, thus increasing the moisture content to a maximum of 40% for Colby cheese and 44% for Monterey Jack cheese.

“Processed cheese” as used herein generally refers to a class of cheese products that are produced by comminuting, mixing and heating one or more varieties of curds or natural cheese into a homogeneous, plastic mass, with emulsifying agents and optional ingredients, depending on the class of processed cheese produced. The comminuted cheese is blended and sent to cookers or the like, which commonly heat the mass to a temperature of 150°-210° F., preferably 165°-190° F. During cooking, fat (if present) is stabilized with the protein and water by the emulsifying agents, which are typically citrate or phosphate salts, usually at a level of about 3%. The emulsifying agents cause the protein to become more soluble. Under these circumstances a stable emulsion of protein, fat and water occurs to provide a smooth, homogeneous mass. The hot mass is packaged directly, or formed into slices and packaged. Pasteurized process American cheese is a class of processed cheese wherein the cheese used to make the processed cheese is predominantly American-type cheese.

Even though the term “processed cheese” is not limited thereby, there are four main classes of processed cheese in the U.S.: pasteurized process cheese, pasteurized process cheese food, pasteurized process cheese spread and pasteurized process cheese product. All four classes of processed cheese are made with emulsifying agents. Standards of identity apply to pasteurized processed cheese and are established by the FDA. By those standards, whey solids, including whey proteins, may not be added to the pasteurized process cheese. The various types of processed cheeses are obtained depending on the processing conditions, the specific varieties of curds or natural cheeses used, and the additional ingredients added during the processing. Cheese sauce is another product which is a processed cheese, and may fit the standard of identity for pasteurized process cheese spread, or may be a non-standard product. Internationally, there are two Codex standards established for processed cheese, i.e., “Process Cheese” (also referred to as “Processed Cheese”) and “Process Cheese Preparation” (also referred to as “Processed Cheese Preparation”). For Process Cheese, cheese constitutes the largest single dairy ingredient used as a raw material, whereas for Process Cheese Preparation, cheese need not constitute the largest dairy ingredient used as a raw material. Both of these international standards also fit within the definition of “processed cheese” as used herein.

“Imitation cheese” is a food made in semblance of any natural cheese variety, processed cheese, or other food made of natural or processed cheese, in which casein, caseinates, and/or safe or suitable non-milk ingredients, such as vegetable proteins, and vegetable oil, replace all or part of the nutritive milk components normally found in the food being simulated.

“Emulsifying agents” as used herein means emulsifying agents that can be used in the making of processed cheese. These include one or any mixture of two or more of the following inorganic salts: monosodium phosphate, disodium phosphate, dipotassium phosphate, trisodium phosphate, sodium metaphosphate, sodium acid pyrophosphate, tetrasodium pyrophosphate, sodium aluminum phosphate, sodium citrate, potassium citrate, calcium citrate, sodium tartrate, and sodium potassium tartrate. In processed cheese, these emulsifying agents act as calcium sequestering (or chelating) agents.

“Acidifying agents” as used herein means any food grade acid, and in particular, those that can be used in the making of processed cheese. These include vinegar, lactic acid, citric acid, acetic acid, phosphoric acid and mixtures thereof.

“Cheese product” as used herein includes compositions made from cheese curds, regardless of how such cheese curds are made. The term “cheese product” includes, and may otherwise be comparable to, conventional cheese (containing very small amounts of whey proteins), UF cheese (containing high levels of whey proteins), processed cheese, imitation cheese and intermediate materials in the processed cheese and imitation cheese making processes. The cheese curds may be made from fresh milk or other dairy liquids such as reconstituted dry milk powder. The fat content of the milk or other dairy liquid may be adjusted before making the cheese curds. Alternatively, the fat content of the cheese product may be adjusted after the curds have been formed when they are made into the cheese product. Preferably the cheese product will have a pH of less than 5.6, a moisture content of less than 60% and contain one or more milk coagulating enzymes, such as a protease, and most commonly rennet. Preferably, the cheese product will contain at least 10% protein by weight, more preferably at least 15% protein by weight and preferably at least 10% casein by weight.

Test Procedures

The present invention and the benefits thereof are most easily understood when described in terms of several standards for evaluating the firmness and melt properties of processed cheese.

Schreiber Melt Test

The L. D. Schreiber melt test is a well-known and accepted standardized test for determining the melt properties of cheese. The test uses a conventional electric kitchen oven and a standardized piece of cheese, and measures the change in size of the cheese piece after it is melted. The instructions for the procedure, as used in tests with results reported below, are as follows:

1. Preheat oven to 450° F. (232.2° C.).

2. Slice cheese 3/16 thick (5 mm). If cheese is already sliced, use 2-3 slices to get closest to the 3/16 thickness.

3. Cut a circle out of the cheese slice using a sharpened metal sampler with a diameter of 39.5 mm.

4. Center the cheese circle in a thin wall 15×100 mm petri dish, cover and place on the center rack of the oven. Do this quickly so the oven temperature does not drop below 400° F. (204.4° C.).

5. Bake for 5 minutes and remove. Up to 4 dishes may be done at the same time.

6. Once cooled, the melt is measured on the score sheet.

The score sheet comprises a series of concentric circles with increasing diameters. The first circle has a diameter of 40.0 mm. Each succeeding circle is 6.5 mm larger in diameter. The melted cheese receives a score of 1 if it fills the first circle, a score of 2 if it fills the second circle, etc. As used herein, the scores include a “+” (or “−”) indicating that the cheese was slightly larger (or smaller) than the indicated score ring.

Mettler Melt Test

The meltabilities of cheeses can also be compared using an apparatus for determination of dropping point or softening point, such as the Mettler FP 800 thermosystem. In such an apparatus, the temperature at which a plug of cheese falls through an orifice is measured. In general, cheeses with acceptable melt characteristics have a Mettler melt temperature below 200° F. Cheeses exhibiting non-melt characteristics will not melt at 230° F., which is the shut-off temperature of the Mettler FP 800 instrument as set up for this test, which prevents the temperature from rising too high and burning non-melting samples inside the instrument. The Mettler FP 800 instrument is set up with the start temperature at 100.0° F. and the heating temperature rate at 5.0° F./minute.

The instructions for sample preparation are as follows:

1. The sample cup (middle piece) is pushed through the cheese sample until the sample extrudes from the small top hole of the cup.

2. A knife is used to carefully trim around the cup and square off cheese at the top and bottom.

3. Samples of cheese are prevented from drying out before being analyzed.

4. The bottom holder and top holder of the sample cup are assembled with the center section.

5. The entire assembly, using the top holder stem, is placed in the oven and gently turned until it is seated on the bottom of the oven.

6. After the sample is placed in the instrument, the run/stop button is pushed. At this point there is a 30 second countdown while the oven temperature equilibrates at 100° F. The oven temperature will begin to rise and will shut off at the softening point of the cheese or at 230° F., in case the cheese does not soften and flow. The softening point reading will be printed on paper, or the end temperature (230° F.) will be printed if the cheese does not soften.

7. A fan inside the oven will turn on to bring the temperature back to 100° F. or below. When the fan has turned off, the entire assembly is removed from the oven and disassembled and cleaned.

Instron Firmness Measurement

The firmness of the cheese is measured by an Instron Tester (Model 5542-Canton, Mass.). The cheese is cut into chunk size (2″×3″×4″) and tempered at 40° F. overnight. A compressive loading force is applied to the cheese sample with a McCormic Fruit Tester plunger (8 mm diameter) attached to a load cell (500 Newton). The maximum force (kg F) recorded for the plunger as it travels downward (at a speed of 330 mm/min.) with a penetration depth of 11 mm into the cheese sample is defined as the firmness of the cheese. As can be appreciated, the firmness of any particular cheese product will be a function of many factors. However, the protein concentration in the product has a great effect on the Instron firmness. Therefore, when comparing the Instron Firmness of two different compositions, it is helpful to take into account the protein concentration. In some of the examples below, a relative Instron firmness number has been calculated by dividing the tested Instron firmness by the percentage of protein in the sample. For example, if a sample had an Instron firmness of 1.6 kg F and a protein level of 16%, the calculated Instron firmness/% protein would be 0.1 kg F/% protein.

### Preferred Embodiments

The preferred method of the present invention can be applied to any fluid milk protein source containing casein. The method produces cheese curds that can be used to make processed cheese, imitation cheese, and other cheese products. Several novel steps, intermediate and final products are also encompassed in the present invention. The basic method of the invention will be described first. The novel steps, intermediate and final products, as well as preferred aspects and variation of the invention, will then be more readily understood.

The basic method of making cheese curds of the present invention involves five basic steps: 1) providing a fluid milk protein source containing casein; 2) mixing a milk coagulating enzyme into the fluid milk protein source; 3) allowing the milk coagulating enzyme to react with the casein; 4) heating the fluid milk protein source containing the enzyme treated casein to a temperature of at least 135° F.; and 5) separating curds formed in the above steps from liquid remaining from the curd formation. The preferred embodiments of the invention include two different methods of carrying out these basic steps. In the first method, the milk coagulating enzyme is allowed to react with the casein for a time sufficient for the fluid milk protein source to form coagulum while at a pH of 5.6 or above; after which the coagulum containing the enzyme treated casein is heated to a temperature of at least 135° F., more preferably at least 150° F., while the fluid milk protein source is at a pH of 5.6 or above, for a time sufficient to cause syneresis of the coagulum and to form curds. In the second method, the milk coagulating enzyme is allowed to react with the casein for at least three hours while at a temperature at which a coagulum does not form; followed by heating the fluid milk protein source containing the enzyme treated casein to a temperature of at least 135° F. for a time sufficient to cause the casein to form curds. Each of these methods includes different variations, as explained below.

As to the first basic step, as noted earlier, virtually any fluid milk protein source containing casein may be used. Most typically skim milk, part skim milk or whole milk will be used. When there is a cost advantage, reconstituted milk may be used. The fluid milk protein source may have a higher solids content than whole milk; or its content may be adjusted in some other respect. For example, condensed milk, ultrafiltered milk, reverse osmosis milk or microfiltered milk may be used. Of course the fluid milk protein source may be provided by mixing two or more different types of milk together. The fluid milk protein source will preferably contain casein and whey proteins at a ratio of casein to whey proteins of greater than 10:1, and a casein concentration of less than 4%. The preferred fluid milk protein source will comprise milk containing casein and having a solids content of between about 7% and about 25%. Unless skim milk is being used, the fluid milk protein source will typically have a fat content of at least 0.5%.

The fluid milk protein source will preferably be pasteurized. Not only will pasteurization make the resulting product safer for food use, but the pasteurization step will deactivate organisms that might interfere with other steps in the process. After raw milk is pasteurized, it will generally be cooled to a temperature of between about 40° F. and about 1 20° F., more preferably between about 80° F. and about 115° F., most preferably between about 95° F. and about 115° F., before the milk coagulating enzyme is mixed with the fluid milk protein source. If the pasteurized milk is cooled and stored, or if milk is reconstituted from a dried milk, it will be heated up to these same temperatures.

The pH of whole milk is generally in the range of 6.6 to 6.7. In some aspects of the invention it will be advantageous to adjust the pH of the fluid milk protein source to between about 5.0 and about 6.5, preferable between about 5.8 and about 6.4, more preferably to between about 5.6 and about 6.2, prior to mixing the milk coagulating enzyme with the fluid milk protein source. In traditional cheese making processes, a starter culture is added, and the lactose in milk is converted to lactic acid by fermentation to reduce the pH. In the present invention it is preferable to adjust the pH by adding an acidifying agent. When used, preferred acidifying agents are lactic acid and acetic acid.

In the second basic step, a milk coagulating enzyme is mixed into the fluid milk protein source, preferably while the fluid milk protein source is in a cheese making vat. As used herein, the term “cheese making vat” is to be understood broadly to include vessels of all shapes and sizes that are of practical use in making cheese in a commercial manner. A preferred milk coagulating enzyme is rennet, such as calf rennet, porcine rennet, microbial rennet and rennet from fungal and vegetable sources. A preferred rennet is fermentation derived chymosin. The amount of milk coagulating enzyme needed will vary depending on the concentration of casein in the fluid milk protein source, the time allowed for the reaction, the pH of the fluid milk protein source and the temperature at which it is carried out. In order to have a fairly quick reaction time, sufficient milk coagulating enzyme must be used and other process conditions must be within acceptable ranges.

The casein in milk is normally present in relatively stable micelles. Rennet induced milk coagulation involves two steps, the enzymatic step where the enzyme reacts with the casein to produce para-casein, and then the coagulation phase, which corresponds to the formation of a gel by aggregation and association of the enzyme modified micelles. The rate of these steps is heavily dependent on temperature and pH. Below about 50° F., the coagulation of milk does not occur. In the range of 50° F. to 68° F., the coagulation rate is slow. Above 68° F., it increases progressively up to 104° F. to 108° F. or higher, depending on the specific milk coagulating enzyme used, and then it diminishes again. For example, fermentation produced chymosin sold under the brand name “Chymax Extra” has an optimum enzyme activity at about 115° F. Above about 150° F., coagulation no longer occurs as the enzyme is heat deactivated. The pH has a primary effect and a secondary effect. The activity of the enzyme is pH dependent. At a pH above 7, the enzyme is inactive. The maximum stability of the enzyme is displayed in a pH range of 5 to 6. The optimal pH for the enzyme to act on the casein is 5.5. Acidification also reduces the micelle stability, thus primarily affecting coagulation. Going from a pH of 6.7 to a pH of 5.6 increases the enzyme activity by a factor of 7, while the rate of aggregation of the micelles is increased by a factor of 30. As a result, this second step is preferably carried out at a temperature in the range of 80° F. to 120° F., more preferably 95° F. to 115° F., and at a pH in the range of 5.6 to 6.7, more preferably in the range of 5.6 to 6.2.

However, in some embodiments of the invention, it may be desirable to add the milk coagulating enzyme to the fluid milk protein source at a low temperature at which a coagulum is not formed, such as less than about 55° F., more preferably less than about 50° F., and let it react for a long time, for example at least three hours, more preferably at least six hours, which may be advantageous if milk is to be held overnight for use to make curds the next day.

Optionally, a source of calcium may be added before a coagulum is formed. This may preferably be added before the milk coagulating enzyme is added, although it can be added at the same time as well. A preferred source of calcium is calcium chloride.

The adjustment of the pH and the addition of calcium are both steps that may be used to affect the resulting properties of the curds and the cheese product made therefrom.

The next basic step in the process is allowing the milk coagulating enzyme to react with the casein. The amount of time required will depend on several factors, including the pH, the concentrations of casein and milk coagulating enzyme, the temperature, and the calcium content. In any event, the time will need to be long enough so that the casein will form curds when heated. In general the enzyme should preferably be given between about 2 minutes and about 90 minutes to react. Lower pH values reduce coagulation time for two reasons. First, lower pH values are a more favorable environment for the basic enzyme activity. Second, a lower extent of kappa-casein proteolysis is required for aggregation of the casein micelles at lower pH values. When the pH is between 5.6 and 6.2, the reaction time will preferably be between about 2 minutes and about 30 minutes. For a pH of between 6.2 and 6.7, the time will preferably be between about 5 minutes and about 60 minutes. Quiescent conditions are also preferred during the step of enzyme reaction. Unless the enzyme reaction step is carried out at a low temperature, a coagulum will form during this step of the invention.

The next basic step of the inventive method is to heat the fluid milk protein source containing the enzyme treated casein to a temperature of at least 135° F. and for a time sufficient to cause the casein to form curds. Preferably the pH of the fluid milk protein source will still be at 5.6 or above. In conventional stirred curd cheese making processes, the rennetted cut coagulum is gradually heated in the cheese making vat to temperatures in the range of only 90° F. to 105° F. One reason that moderate temperatures and slow heating rates are used is so that microbial activity will not be destroyed, and the cheese can then continue to age after it is formed. The present invention utilizes much higher temperatures. The temperature will normally be in the range of between about 135° F. and about 200° F. A preferred temperature range is between about 150° F. and about 200° F. More preferably the temperature will be between about 150° F. and about 180° F. Most preferably the temperature will be at least about 160° F. At these temperatures, if a starter culture were used, the starter activity would be deactivated significantly. However, as the curds are primarily intended for use in making processed cheese, and it is desirable to be able to use the curds soon, if not immediately, after they are made, the high temperatures for this step are not detrimental to the quality of the intended finished product. It is believed that a composition consisting essentially of a fluid milk protein source containing casein and milk coagulating enzyme in the form of coagulum at a temperature of at least about 160° F. is itself novel.

At these high temperatures, syneresis occurs very rapidly. The curds expel liquid, which includes whey protein if present, as well as other soluble components in the original fluid milk protein source, such as lactose. Temperatures of 160° F. and above have been found to give very good results.

If a coagulum is formed before the milk coagulating enzyme treated material is heated, the coagulum can be cut or otherwise broken in a separate step before the material is heated, or it can be broken as it is heated. Sometime it is preferable to cut the coagulum and then allow some time to pass for the coagulum to “heal” before the cut coagulum is heated. If no coagulum is formed before heating is started, the coagulation step will lead to the formation of curds simultaneously with the heating, with no real separate step of forming a coagulum. Preferably, when making the product in a cheese making vat, the cutting occurs not more than 10 minutes after the milk coagulating enzyme is mixed with the milk, and the heating occurs over a period of not greater than 20 minutes, the duration of the heating period being measured from the time beginning when the cut coagulum begins to be stirred and its temperature is elevated, and ending when the whey starts to be separated.

As noted above, in addition to a higher temperature, the preferred embodiment of the invention involves a more rapid heating of the fluid milk protein source after the enzyme treatment than is used in conventional cheese making processes. In conventional stirred curd cheese making, the cut coagulum is heated about 12° F. over a period of about 30 minutes. In the preferred embodiments of the invention, that heating is done much more quickly. Preferably the fluid is heated at a rate of at least 3° F./min. The preferred method of heating the milk coagulating enzyme treated material is in a continuous flow process, such as with a heat exchanger. Even more preferred is to heat the material by direct steam injection, which can be done by introducing steam into a vessel, such as a cheese vat, containing the milk coagulum, or by adding the steam while the milk coagulum is flowing through a tube or pipe. Of course the heating may be accomplished by more than one method, in series or simultaneously. For example, conductive surface heating using a steam jacketed vessel, or a swept surface heat exchanger, may be used alone or with steam injection. A particularly preferred heating method uses a “PICK heater,” which adds steam to the material as it flows, thus providing direct steam injection heating in a continuous flow process. With direct steam injection, very quick heating rates are possible. The temperature is increased in such a heater almost instantaneously. The heating rate is a function of the flow rate of the cut coagulum through the device, the flow rate of steam injection into the device, and the turbulence of the flow through the device. In a preferred direct steam injection, continuous flow heater, the heating rate will preferably be above 10° F./sec.

Preferably the heated material will be cooled to a temperature of less than 120° F. before it is separated. More preferably it will be cooled to a temperature in the range of about 40° F. to about 90° F. prior to separation. The material may be cooled by passing it through a heat exchanger, or by adding cold water, or even by taking the liquid separated at an earlier time, cooling it down, and then mixing that liquid back in.

If the fluid milk protein source comprises milk, the liquid remaining from the heating step and formation of curds will be whey, containing water, whey proteins, lactose and minerals.

Preferably the separation step will begin to occur within a period of less than one minute from when the fluid begins to be heated. The separation can be carried out by many suitable methods. The preferred methods are centrifugal separation, vibratory screening, pressing, vacuum separation and combinations thereof.

Once the curds are formed and separated they can be used immediately to make cheese products. Alternatively they can be packaged and stored for later use. If the curds are to be stored, they should be cooled down to a temperature of 40° F. or below, and mixed with an acidifying agent to have a pH below 5.6, for food safety purposes. Cold brine may be used to help cool the curds. In another alternative, the curds can be dried to a moisture content of less that 12% and stored. In this alternative, the dried curds are preferably also ground, producing a product much like rennet casein.

It was discovered during the development of the invention that curds formed from skim milk will usually be harder to make into processed cheese than cheese curds from whole milk made in a conventional manner. This is especially true for skim curd made using the high temperature heating step of the present invention, particularly those made at a pH so that high levels of calcium are retained in the curd. Such a skim curd can be used immediately after it is made, and even if it is not, it does not experience the same protein breakdown and softening experienced by conventional cheese as it ages. It has been found that the difficulty can be solved by grinding the curds to a smaller than typical size. Preferably the curds will be ground to a weight average particle size of about 1.5 mm or less before being used to make processed or imitation cheese. (The particle size, as that term is used herein, is based on the longest dimension of the particle.) An Urschel grinder (model 3600, Urschel Laboratories, Valparaiso, Ind.) equipped with an Urschel type 3B-020035 cutting head produces cheese curd particles with a weight average particle size of about 1.5 mm.

As discussed later, an emulsifying agent can be mixed with the ground curds to help prepare them for use in making processed or imitation cheese. The small particle size from the grinding increases the surface area of the material to allow faster heat transfer and reaction with the emulsifying agent in the cooking operation. Also, if the emulsifying agent is mixed with the ground curds before being placed in the cooker, this pretreatment will allow some advantageous emulsifier reaction time even before the heat is applied during the cooking step.

To make a cheese product, one or more additional ingredients will be mixed with the curds. If a cutting cheese for direct consumption is to be formed, salt (sodium chloride) and an acidifying agent can be mixed with the cheese curds and the curds packed into a form, such as a block or barrel. Thereafter the formed cheese will be cut into customer-size cut portions and sold in its cut form.

When the curds (especially skim milk curds) are going to be used to make a processed cheese, the ground curds can be pretreated with an emulsifying agent. A preferred emulsifying agent is sodium citrate, but other emulsifying agents can be used. The pretreated ground curds in this composition will preferably comprise over 10% emulsifying agent by weight of the protein. Preferably, the ratio of curds to emulsifying agent will be between about 100:1 and about 100:15, and more preferably between about 100:2 and 100:10.

Other additional ingredients that may be mixed with the curds to make cheese products include milkfat, salt (such as sodium chloride or potassium chloride) and acidifying agents such as citric acid. These can be mixed with the curds at the same time as the emulsifying agent, or in the case of skim milk curds, preferably after the pretreatment step. The pretreatment step, as well as the step of mixing in additional ingredients, can take place in a blender or some other piece of equipment, or it may take place directly in a processed cheese cooker. In a preferred embodiment, only the emulsifying agent and ground curds are mixed together in a pretreatment step so that the reaction between the emulsifying agent and ground curds can be optimized. Not all of the emulsifying agent that will be found in the final cheese product need be used in the pretreatment process. The additional ingredients mixed with the pretreated ground curds can include additional emulsifying agent. The pretreatment step may take place fairly soon before the ground curds are used to make processed cheese. However, in some embodiments of the invention, pretreated ground skim milk curds may be stored for at least 12 hours before they are used to make processed cheese. Preferably the curds are mixed with additional ingredients to make the processed cheese within 24 hours of being separated or are mixed with an acidifying agent and stored for at least 24 hours before being used to make the processed cheese. As noted in the examples below, conventional cheese can be mixed with the cheese curds made by the present invention when making processed cheese.

As can be seen from the above, the entire process can be carried out rapidly. For example, depending on the process parameters and quantities, in less than two hours, preferably in less than one hour, and more preferably in less than 30 minutes, after the milk coagulating enzyme is mixed with the fluid milk protein source, additional ingredients can be mixed with the curds to make the cheese products. Preferably the curds are separated from the liquid remaining from the curd formation process within about 10 minutes or less after the fluid milk protein source containing the enzyme treated casein is heated. Another way of considering the rapidity of the preferred process is that in a continuous-flow heating operation of a coagulum, some of the curds can be used to make the cheese product almost instantly after the coagulum is cut. For a pump and heater processing 100 gallons/min., about 900 pounds of cut coagulum per minute can be turned into curds. The rate at which the curds will be produced can easily be increased simply by increasing the throughput size or number of heaters. The process can be scaled up in speed simply by equipment design, because the process does not require time for starter culture to act and produce a lower pH through fermentation. Preferably the curds can be used to make the cheese product within less than about 1.5 minutes/1000 pounds of heated coagulum, after the coagulum is cut. By contrast, a conventional process in which 50,000 pounds of cut coagulum is heated, the whey separated and the curd stirred while the pH drops, may take over 2 hours after the coagulum is cut before salt is added and the curds are ready to be packed.

The curds can be used to make processed cheese, imitation cheese and other cheese products, including cheese sauce. Preferably the curds will be used to make a processed cheese having a composition which is functionally and compositionally comparable to a pasteurized process cheese, pasteurized process cheese food, pasteurized process cheese spread or pasteurized process cheese product. Most preferably the processed cheese will have the same composition as required of a pasteurized process American cheese. Preferred cheese products have a composition comprising about 39% to about 40% moisture, about 30% to about 33% fat, about 17% to about 19% protein and about 2% to about 2.5% salt. Because no starter culture is used in the preferred process, and because of the high temperature heating step, the curd will preferably have a low bacterial count, less than 25,000 cfu/gram.

One method embodiment of the present invention was developed with the goal of producing skim curds rapidly, but in such a state so that they could be readily cooked in typical processed or imitation cheese manufacturing equipment. To achieve this goal, it was discovered that controlling the calcium content of the curds was an important compositional parameter in the manufacture of processed or imitation cheese. In general, the state of the calcium in milk (colloidal or soluble) can be controlled with pH adjustments. When pH is reduced, more colloidal or “protein-bound” calcium will solubilize and move out into the serum phase of milk and become “soluble calcium”. Alternatively, as pH is increased the opposite effect occurs. Therefore by pH manipulation and subsequent rennet coagulation, one can control the residual amount of calcium left in the curds (colloidal) and the amount of calcium lost to the whey stream (soluble). Preferably the skim milk curds have a solids content of between about 30% and about 50%, a protein content of between about 24% and about 42%, a fat content of less than 1%, and a lactose content of at least 1.5%.

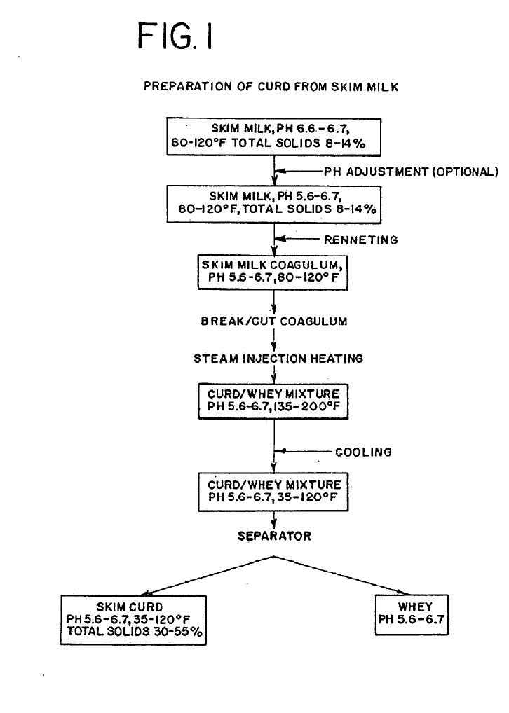

FIG. 1 shows a flow chart for a preferred process of making skim milk curds. The prepared and pH-adjusted skim milk goes through a fairly typical rennet coagulation process in its initial stages. However, the heating step itself, and preferable when it occurs, is modified. In this process, skim milk with a pH of about 6.6-6.7, having a total solids content of 8-14%, is used. The skim milk will typically be pasteurized. It will then be cooled down to the desired temperature, preferably between 80° F. and 120° F. In a first basic option, the pH is adjusted, preferably by the addition of acid, to a range of 5.6 and above. Rennet is added and allowed to react with the casein in the skim milk, forming a coagulum. This coagulum is cut or otherwise broken. Heat is then applied rapidly and extensively via direct steam injection to reach temperatures of between 135° F. and 200° F., while the pH remains at 5.6 or above. This achieves the proper amount of curd shrinkage and whey expulsion in a very short time. This rapid, high heat treatment also causes the development of very firm and tightly ordered skim curd particles. The curd/whey mixture is then cooled to a temperature in the range of 35° F. to 120° F., after which the whey and skim curds are separated. The skim curds have a solids content of between 30% and 55%.

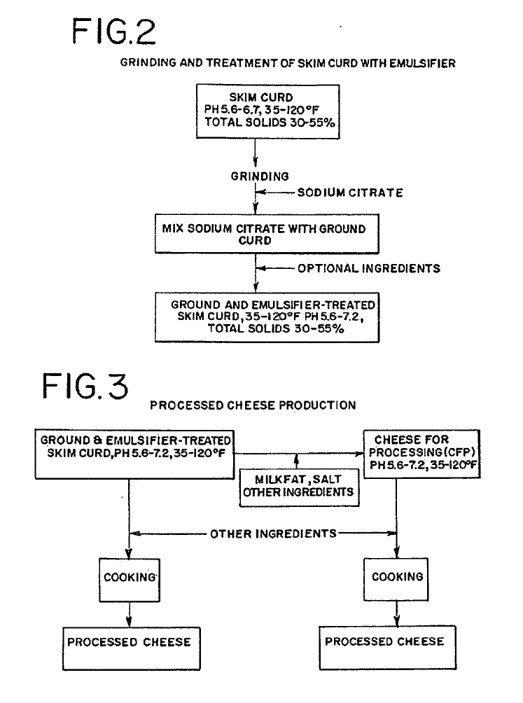

The skim curd particles resulting from the process of FIG. 1 are difficult to cook in normal processed or imitation cheese manufacturing systems. To overcome this cookability problem, as shown in FIG. 2, fine grinding, such as Urschel grinding, is used to reduce the curd particle size to a weight average particle size of about 1.5 mm or less, after which sodium citrate is added to the ground curds to function as a calcium sequestrant, which effectively reduces the number of intermolecular calcium-mediated linkages between and within the casein molecules. This combined mechanical and chemically-mediated “de-structuring” allows the skim curds to be readily and fully-utilized when cooked in normal processed cheese manufacturing systems. The sodium citrate also increases the pH of the material, up to as much as a pH of 7.2.

FIG. 3 shows two basic options for converting the ground and emulsifier treated skim curd into processed cheese. In the first option, shown at the top and right side of FIG. 3, milkfat, salt and other ingredients are mixed with the ground curds. This mixture, called “cheese for processing” (CFP), has a composition that is comparable to conventional barrel cheese used for making processed cheese. This CFP may be held under proper conditions, or used immediately to make processed cheese. Continuing with this option, the other typical processed cheese ingredients are added, and the material is cooked and packaged just as conventional processed cheese. In the second option, shown on the left side on FIG. 3, all ingredients needed to make the processed cheese from the skim curd are mixed in when the processed cheese is made. If a normal fat-content processed cheese is made, these ingredients will include the milkfat (added in a separate step in the first option). The material is then cooked and packaged as processed cheese. Imitation cheese products can be made from the ground curds similar to the way that processed cheese is made, using vegetable oil instead of milkfat.

When pH has been controlled, both curd calcium content and the extent of calcium sequestration through the action of sodium citrate is able to be controlled. In experiments using the skim curds for processed cheese manufacture, a substantial increase in the finished processed cheese firmness was found, which can be a major advantage in manufacture of superior processed cheese products. One of the key features of this invention is thus the development of a rapid method for production of skim curds with improved protein functionality over normal cheese protein supplied via full-fat barrel cheese made by traditional methods.

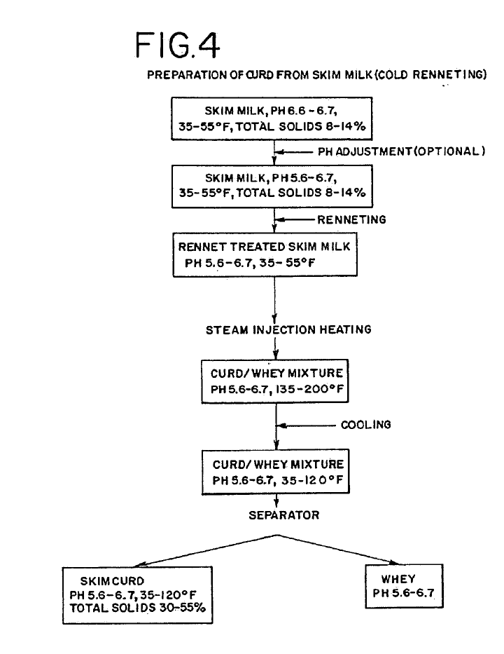

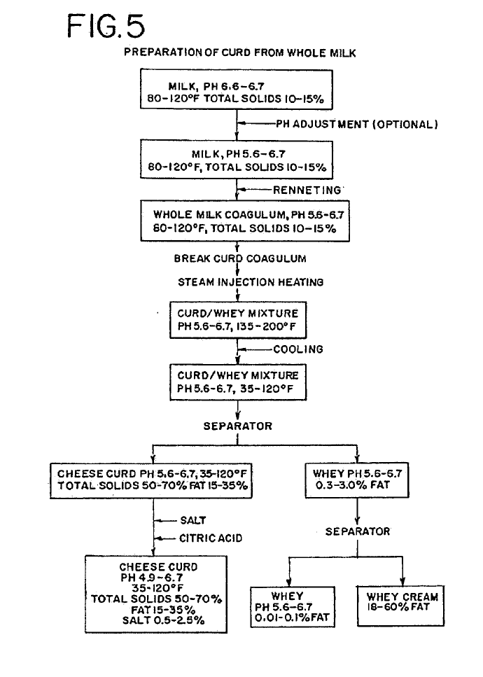

FIG. 4 shows an alternate process for preparing curds from skim milk using a low temperature renneting step. Like the process in FIG. 1, this process begins with pasteurized skim milk that has been cooled. However, in this process the skim milk is cooled to 35° F. to 55° F. The typical skim milk will have a pH of about 6.6-6.7, and a total solids content of between 8% and 14%. The pH may optionally be lowered to 5.6 or above before the rennet is added. The skim milk is kept at a low temperature so that the renneted milk will not coagulate. At these low temperatures, it will normally take quite a while for the rennet to convert the casein to para-casein. This process with most likely be used when overnight storage of the rennet-treated skim milk is available. When the material is later rapidly heated to 135° F. to 200° F., such as by direct steam injection, the material forms a curd very rapidly. Thereafter the rest of the process is just as in FIG. 1, and the resulting curds can be treated as in the process of FIG. 2 and made into processed cheese by either of the options shown in FIG. 3.

FIG. 5 shows a preferred process for making cheese curds and processed cheese from whole milk. Like the process of FIG. 1, the milk begins at a pH of 6.6-6.7 and a temperature of 80-120° F. However, because whole milk is used, the total solids will be in the range of 10-15%. The pH may optionally be adjusted to 5.6 or above. The rennet is added and allowed to react with the casein and a coagulum is formed. The coagulum is broken and the coagulum is rapidly heated by direct steam injection to a temperature in the range of 135-200° F. This causes syneresis and curd formation. The curd/whey mixture is cooled to a temperature in the range of 35-120° F. and separated. Some of the fat that was in the original milk will be lost from the curds and come out with the whey. The curds will have a fat content of 15-35%, while the whey will have a fat content of 0.3-3%. The whey will preferably be subject to another separation step in which the milkfat is recovered, producing a whey cream with a fat content of 18-60%. Meanwhile the cheese curd is converted to a material that can be used to make processed cheese by having salt and citric acid added. The citric acid brings the pH of the curds down to 4.9 or above. If the pH is low enough, these curds can be stored just like conventional barrel cheese.

Examples 1-7 below use the process outlined in FIGS. 1-3 in the production of curd from skim milk and the use of that curd in processed and imitation cheese. Examples 8-9 use the process of FIG. 5 in the production of curd from whole milk. Example 10 uses the process outlined in FIG. 4 in the production of curd from skim milk using a low temperature renneting process.

### EXAMPLE 1

Preparation of Skim Curds (pH 6.6)

To prepare reconstituted skim milk, 78.5 lb of nonfat dry milk (NFDM) (Dairy America, Fresno, Calif.) was mixed with 775 lb cold water (45° F.) in a 200 gallon milk tank with a 16″ agitating propeller blade operating at 94 rpm. The NFDM/water mixture was kept cold (<45° F.) with continuous agitation overnight to insure complete hydration of the NFDM solids.

The reconstituted skim milk had the proximate composition shown in Table 1.

TABLE 1

| | % Total | % | % | % | |
|---|---|---|---|---|---|
| | Solids | Protein | Lactose | Ash | pH |
| Recon. Skim Milk | 9.04 | 3.19 | 4.25 | 0.77 | 6.6 |

The reconstituted skim milk was warmed to 90° F. with hot water (190° F.) jacket heating. Rennet was added (57 ml) (Chymax Extra (2×), Chris Hansen, Milwaukee, Wis.) into the skim milk with the agitator on for one minute. Rennet treatment of the milk was allowed to continue for an additional 60 minutes with the agitator off. The skim milk clotted and formed a continuous soft gel coagulum which was then broken/cut by the agitator blade. The broken coagulum mixture was then pumped out with a positive displacement Sine pump (Model SPS-20, Konto Co. Inc., Orange, Mass.) at a rate of 3.3 gpm. Hot steam (80 psig) was directly injected into the pipe at the outlet of the Sine pump, using a PICK heater device (PICK Sanitary Heater, model SC-2, West Bend, Wis.). The broken coagulum mixture (90%) was thus immediately heated to 160° F. by the steam injection. Heating of the broken/cut renneted coagulum mixture accelerated the syneresis of the whey and formed high-solids content curds.

The resulting curds/whey mixture flow (160° F.) was then cooled to 110° F. by passing through two 8-foot shell and tube cooling devices (2 inches in diameter) in which chilled water (43° F.) was flowing counter-current in the outer jacket of the cooling device. The cooled curds/whey mixture (110° F.) was then fed into a Sweco separator (Sweco Separator, model LS 30S 66-30, Florence, Ky.) to separate the curds and whey. The separated curds cooled further in the Sweco separator to 105° F. and were then packed into 40 lb cheese hoops and lightly pressed for 10 minutes to expel any free whey trapped in the curd matrix. The pressed skim curds (95° F.) were finely ground in an Urschel grinder (model 3600, Urschel Laboratories, Valparaiso, Ind.) equipped with an Urschel type 3B-020035 cutting head. The proximate composition of the ground and composited skim curds and the composite whey were as shown in Table 2.

TABLE 2

| | % Total | % | % | % | |
|---|---|---|---|---|---|
| | Solids | Protein | Lactose | Ash | pH |
| Skim curds | 42.24 | 35.28 | 1.97 | 3.91 | 6.57 |
| Separated whey | 6.34 | 0.89 | 3.83 | 0.42 | 6.70 |

### EXAMPLE 2

Treatment of Skim Curds (pH 6.6) with Sodium Citrate

Twenty lbs of Urschel-ground skim curds from Example 1 were mixed with 0.75 lb of sodium citrate for 2 minutes in a 50 lb twin-screw Reitz blender with the auger speed set at 44 rpm. The sodium citrate-treated skim curds had a composition as shown in Table 3.

TABLE 3

| | % | % | % | |
|---|---|---|---|---|
| | Moisture | Protein | Lactose | pH |
| Skim curds | 56.02 | 34.02 | 1.90 | 7.03 |

### EXAMPLE 3

Processed Cheese made with Sodium Citrate-Treated Skim Curds

Processed cheese formulas containing conventional barrel cheese only (Formula 3A) and sodium citrate-treated skim curds from Example 2 (Formula 3B) were calculated and are shown in Table 4.

TABLE 4

Processed Cheese Formula
(lbs. per 10 lb cook)

| Cheese/Ingredient | Formula 3A | Formula 3B |
|---|---|---|
| Barrel cheese (7 day old) | 5.70 | 2.80 |
| Sodium citrate-treated | 0 | 2.25 |
| skim curds from | | |
| Example 2 (4 days old) | | |
| Sodium Citrate | 0.33 | 0.25 |
| Sorbic Acid | 0.02 | 0.02 |
| Sodium Chloride | 0.16 | 0.21 |
| NFDM | 0.71 | 0.58 |
| Conc. Milkfat (CMF) | 1.42 | 2.66 |
| Lactic Acid | 0 | 5 grams |
| Water | 1.66 | 1.50 |
| Total Weight | 10 | 10 |

Both formulas were targeted at the same finished product composition (39.8% moisture, 31.0% fat, 2.55% sodium chloride and 4.0% lactose) and contained the same amount of sodium citrate solids (2.9%). Due to the sodium citrate treatment of the skim curds (Example 2), the addition of sodium citrate as the processed cheese emulsifying agent was adjusted accordingly, from 0.33 lb/10 lb (in Formula 3A) to 0.25 lb/10 lb (in Formula 3B).

The cheese and ingredient blends (Formulas 3A & 3B) were cooked in a 10 lb. twin-screw Reitz cooker with indirect steam jacket heating at an auger speed setting of 86 rpm. The blend mixture was cooked to 175° F. for 10 minutes to form a homogenous molten plastic body, which was discharged from the cooker and collected into 14 ounce tubs for cooling (40° F., 3 days). The proximate composition, melt properties, and Instron firmness of the finished processed cheese are shown in Table 5.

TABLE 5

| | | Processed Cheese | | | | | | | |
|---|---|---|---|---|---|---|---|---|---|
| | | | | | | | | Firmness | |
| | | | | | % | Meltability | | Instron | Instron |
| | | % | % | % | Sodium | SFI | Mettler | Firmness | kg F/% |
| Formula | Cheese Type | Moist. | Fat | Protein | chloride | Melt | Melt (° F.) | (kg F) | protein |
| 3A | Barrel cheese | 40.55 | 30.5 | 17.02 | 2.88 | 5 | 137 | 1.175 | 0.069 |
| | only | | | | | | | | |
| 3B | Barrel cheese & | 40.81 | 31.0 | 16.85 | 2.86 | 5 | 142 | 1.607 | 0.095 |
| | sodium citrate- | | | | | | | | |
| | treated skim curds | | | | | | | | |

The finished processed cheese (Formula 3B) containing sodium citrate-treated skim curds had acceptable flavor, body, and melt properties as compared to the control product (Formula 3A). As compared to Formula 3A, the approximately 37% increase in Instron firmness of the finished processed cheese containing sodium citrate-treated skim curds (Formula 3B) indicated an improved level of protein functionality of the skim curds prepared by the process shown in Example 1.

### EXAMPLE 4

Preparation of Skim Curds (pH 5.6)

To prepare reconstituted skim milk, 120 lb of nonfat dry milk (NFDM) (Dairy America, Fresno, Calif.) was mixed with 880 lb cold water (45° F.) in a 200 gallon milk tank with a 16″ agitating propeller blade operating at 94 rpm. The NFDM was reconstituted for three hours, after which 1200 ml of acetic acid (diluted 50% with water) was added to reduce the pH to about 5.6. The acidified NFDM/water mixture was kept cold (<45° F.) with continuous agitation overnight to insure complete hydration of the NFDM solids. The reconstituted skim milk had the proximate composition shown in Table 6.

TABLE 6

| | % Total | % | % | % | |
|---|---|---|---|---|---|
| | Solids | Protein | Lactose | Ash | pH |
| Recon. Skim Milk | 12.56 | 4.38 | 4.58 | 1.01 | 5.6 |

The reconstituted skim milk was warmed to 93° F. with hot water (190° F.) jacket heating. Rennet was added (60.6 ml) (Chymax Extra (2×), Chris Hansen, Milwaukee, Wis.) into the skim milk with the agitator on for 2 minutes. Rennet treatment of the milk was allowed to continue for an additional 5 minutes with the agitator off. The skim milk clotted and formed a continuous soft gel coagulum which was then broken/cut by the agitator blade for 1 minute, after which the agitator was shut off and the soft curds were allowed to heal for 9 minutes. The agitator was turned on again and the broken coagulum mixture was then pumped out with a positive displacement Sine pump (Model SPS-20, Konto Co. Inc., Orange, Mass.) at a rate of 3.7 gpm. Hot steam (80 psig) was directly injected into the pipe at the outlet of the Sine pump, using a PICK heater device (PICK Sanitary Heater, model SC-2, West Bend, Wis.). The broken coagulum mixture (90° F.) was thus immediately heated to 160° F. by the steam injection. Heating of the broken/cut renneted coagulum mixture accelerated the syneresis of the whey and formed high-solids content curds.

The resulting curds/whey mixture flow (160° F.) was then cooled to 120° F. by passing through two 8-foot shell and tube cooling devices in which chilled water (43° F.) was flowing counter-current in the outer jacket of the cooling device. The cooled curds/whey mixture (110° F.) was then fed into a Sweco separator (Sweco Separator, model LS 30S 66-30, Florence, Ky.) to separate the curds and whey. The separated curds cooled further in the Sweco separator to 105° F. and were then packed into 40 lb cheese hoops and lightly pressed to expel any free whey trapped in the curd matrix. The pressed skim curds (95° F.) were very finely ground in an Urschel grinder (model 3600, Urschel Laboratories, Valparaiso, Ind.) equipped with an Urschel type 3B-020035 cutting head. The proximate composition of the ground and composited skim curds and the composite whey were as shown in Table 7.

TABLE 7

| | % Total | % | % | % | |
|---|---|---|---|---|---|
| | Solids | Protein | Lactose | Ash | pH |
| Skim curds | 50.84 | 42.96 | 1.72 | 3.32 | 5.73 |
| Separated whey | 9.07 | 1.11 | 4.72 | 0.71 | 5.76 |

### EXAMPLE 5

Treatment of Skim Curds (pH 5.6) with Sodium Citrate

Forty lbs of Urschel-ground skim curds from Example 4 were mixed with 1.5 lb of sodium citrate for 2 minutes in a 50 lb twin-screw Reitz blender with the auger speed set at 44 rpm. The sodium citrate-treated skim curds had a composition as shown in Table 8.

TABLE 8

| | % | % | % | |
|---|---|---|---|---|
| | Moisture | Protein | Lactose | pH |
| Skim curds | 49.16 | 42.96 | 1.72 | 5.73 |

### EXAMPLE 6

Processed Cheese Made with Sodium Citrate-Treated Skim Curds

Processed cheese formulas containing conventional barrel cheese only (Formula 6A), sodium citrate-treated skim curds from Example 5 (Formula 6B), a combination of conventional barrel cheese and other natural cheeses (Formula 6C), and a combination of conventional barrel cheese, other natural cheeses, and sodium citrate-treated skim curds from Example 5 (Formula 6D) were calculated and are shown in Table 9.

TABLE 9

| | Processed Cheese Formula | | | |
|---|---|---|---|---|
| | (lbs. per 10 lb cook) | | | |
| | Formula | Formula | Formula | Formula |
| Cheese/Ingredient | 6A | 6B | 6C | 6D |
| Barrel cheese curds | 5.98 | 0 | 3.12 | 0 |
| Other natural cheeses | 0 | 0 | 3.47 | 3.6 |
| Sodium citrate- | 0 | 4.21 | 0 | 1.95 |
| treated skim curds | | | | |
| (from Example 5) | | | | |
| Sodium citrate | 0.34 | 0.16 | 0.34 | 0.26 |
| Sorbic Acid | 0.02 | 0.02 | 0.02 | 0.02 |
| Sodium Chloride | 0.13 | 0.23 | 0.12 | 0.17 |
| NFDM | 0.76 | 0.65 | 0.64 | 0.57 |
| Conc. Milkfat (CMF) | 1.26 | 3.91 | 0.9 | 2.24 |
| Lactic Acid | 0 | 15 ml | 0 | 10 ml |
| Water | 1.50 | 0.81 | 1.39 | 1.20 |
| Total Weight | 10 lb | 10 lb | 10 lb | 10 lb |

All formulas were targeted at the same finished product composition (39.5% moisture, 30.4% fat, 2.3% sodium chloride and 3.95% lactose) and contained the same amount of sodium citrate solids (3.0%). Due to the sodium citrate treatment of the skim curds (Example 5), the addition of sodium citrate as the emulsifying agent was adjusted accordingly, from 0.34 lb/10 lb in Formulas 6A and 6C, to 0.16 lb/10 lb in Formula 6B, and to 0.26 lb/10 lb in Formula 6D.

The cheese and ingredient blends (all formulas) were cooked in a 10 lb. twin-screw Reitz cooker with indirect steam jacket heating at an auger speed setting of 54 rpm. The blend mixture was cooked to 175° F. for 10 minutes to form a homogenous molten plastic body, which was discharged from the cooker and collected into 14 ounce tubs for cooling (40° F., 3 days). Cheese cooks were made with barrel cheese curds and sodium citrated-treated skim curds (Formulas 6A and 6B) at 1 and 7 days of age, and with the barrel cheese curds and sodium citrate-treated skim curds (Formulas 6C and 6D) at 40 days of age. The proximate composition, melt properties, and Instron firmness of the finished processed cheeses are shown in Table 10.

TABLE 10

| | | Processed Cheese | | | | | | | |
|---|---|---|---|---|---|---|---|---|---|
| | | | | | | | | Firmness | |
| | | | | | % | Meltability | | Instron | Instron |
| | | % | % | % | Sodium | SFI | Mettler | Firmness | kg F/% |
| Formula | Cheese Type | Moist. | Fat | Protein | chloride | Melt | Melt (° F.) | (kg F) | protein |
| 6A | Barrel cheese only | 39.05 | 33.0 | 16.59 | * | 5 | * | 1.94 | 0.117 |
| (day 1) | | | | | | | | | |
| 6B | Barrel cheese & | 36.68 | 34.0 | 17.94 | * | 4 | * | 4.48 | 0.249 |
| (day 1) | sodium citrate- | | | | | | | | |
| | treated skim curds | | | | | | | | |
| 6A | Barrel cheese only | 38.81 | 33.0 | 16.48 | * | 5 | * | 1.91 | 0.116 |
| (day 7) | | | | | | | | | |
| 6B | Barrel cheese & | 36.66 | 33.0 | 19.78 | * | 2 | * | 4.74 | 0.240 |
| (day 7) | sodium citrate- | | | | | | | | |
| | treated skim curds | | | | | | | | |
| 6C | Barrel cheese & | 38.20 | 32.0 | 17.17 | 2.66 | 5 | 150.0 | 1.63 | 0.097 |
| (day 40) | other natural cheese | | | | | | | | |
| 6D | Barrel cheese & | 37.62 | 32.0 | 17.73 | 2.61 | 3 | 161.4 | 2.86 | 0.162 |
| (day 40) | other natural cheese | | | | | | | | |
| | & sodium citrate- | | | | | | | | |
| | treated skim curds | | | | | | | | |

* Data not collected

The finished processed cheese (Formulas 6B and 6D) containing sodium citrate-treated skim curds had acceptable flavor, and body, and slightly lower melt properties, as compared to the control products (Formulas 6A and 6C). As compared to Formula 6A and 6C, the increase in Instron firmness of the finished processed cheese containing sodium citrate-treated skim curds (Formula 6B (over a 100% increase compared to 6A) and 6D (approximately 67% increase compared to 6C)) indicates an improved level of protein functionality of the skim curds prepared by the process shown in Example 4.

### EXAMPLE 7

Imitation Cheese Made with Sodium Citrate-Treated Skim Curds (pH 6.6 & pH 5.6)

Imitation cheese formulas were calculated using rennet casein powder as the protein source (Formula 7A), sodium citrate-treated skim curds (pH 6.6) from Example 2 (Formula 7B), and sodium citrate-treated skim curds (pH 5.6) from Example 5 (Formula 7C) and are shown in Table 11.

TABLE 11

| | Imitation Cheese Formulas | | |
|---|---|---|---|
| | (lbs. per 10 lb cook) | | |
| Cheese/Ingredient | Formula 7A | Formula 7B | Formula 7C |
| Rennet casein powder | 2.22 | 0 | 0 |
| Sodium citrate-treated | 0 | 5.46 | 0 |
| skim curds (pH 6.6) | | | |
| (from Example 2) | | | |
| Sodium citrate-treated | 0 | 0 | 4.20 |
| skim curds (pH 5.6) | | | |
| (from Example 5) | | | |
| Sodium citrate | 0.28 | 0.05 | 0.11 |
| Starch | 0.30 | 0.30 | 0.34 |
| Sodium chloride | 0.22 | 0.25 | 0.25 |
| Whey powder | 0.15 | 0.15 | 0.15 |
| Vegetable oil | 2.18 | 2.20 | 2.18 |
| Lactic Acid | 0.10 | 0 | 0 |
| Water | 4.55 | 1.6 | 2.77 |
| Total Weight | 10 lb | 10 lb | 10 lb |

All formulas were targeted at the same finished product composition (49.0% moisture, 21.8% fat, 2.5% sodium chloride and 18.1% protein) and contained the same amount of sodium citrate solids (2.5%). Due to the sodium citrate treatment of the skim curds (Examples 2 & 5) the addition of sodium citrate as the emulsifying agent was adjusted accordingly, from 0.28 lb/10 lb in Formula 7A, to 0.05 lb/10 lb in Formula 7B, and to 0.11 lb/10 lb in Formula 7C.

The cheese and ingredient blends (all formulas) were cooked in a 10 lb. twin-screw Reitz cooker with direct steam jacket heating at an auger speed setting of 51 rpm. The blend mixture was cooked to 190° F. for 8 minutes to form a homogenous molten plastic body. It was necessary to add an additional 0.05 pounds of sodium citrate (making a total of 0.1 pounds in addition to the sodium citrate in the pretreated product) to Formula 7B in order to form a homogeneous cheese body. The products were discharged from the cooker and collected into 14 ounce tubs for cooling (40° F., 3 days). The proximate composition, melt properties, and Instron firmness of the finished imitation cheeses are shown in Table 12.

TABLE 12

| | | Imitation Cheese | | | | | | | |
|---|---|---|---|---|---|---|---|---|---|
| | | | | | | | | Firmness | |
| | | | | | % | Meltability | | Instron | Instron |
| | Ingredient/ | % | % | % | Sodium | SFI | Mettler | Firmness | kg F/% |
| Formula | Cheese Type | Moist. | Fat | Protein | chloride | Melt | Melt (° F.) | (kg F) | protein |
| 7A | Rennet casein | 48.71 | 22.5 | 18.39 | 2.24 | 4 | 206 | 2.680 | 0.146 |
| 7B | Sodium citrate- | 50.34 | 21.5 | 16.39 | 2.36 | 2 | 226 | 1.561 | 0.095 |
| | treated skim curds | | | | | | | | |
| | (pH 6.6) (from | | | | | | | | |
| | Ex. 2) | | | | | | | | |
| 7C | Sodium citrate- | 48.28 | 23.5 | 15.90 | 2.56 | 3 | 176 | 1.735 | 0.109 |
| | treated skim curds | | | | | | | | |
| | (pH 5.6) (from | | | | | | | | |
| | Ex. 5) | | | | | | | | |

The finished imitation cheeses (Formulas 7B and 7C) containing sodium citrate-treated skim curds had acceptable flavor and body, and slightly lower melt properties, as compared to the control product (Formula 7A). The low Instron firmness of Formula 7B can be explained by the additional emulsifier used during cooking. Formula 7C had a low Instron firmness compared to Formula 7A due to the use of a low pH skim curd in Formula 7C, compared to the use of rennet casein in Formula 7A, which is typically at a pH of about 7.

### EXAMPLE 8

Preparation of Cheese Curds (pH 5.1) from Standardized Milk

670 lb. standardized milk (total solids=13.06%, fat=3.81%, protein=3.07% and pH=6.64) was added to a jacketed 200 gallon milk tank with a 16″ agitating propeller blade. 170 ml acetic acid (diluted 50% with water) was slowly added to the milk with the agitator running at 94 rpm until pH 6.2 was achieved. The agitator was stopped and the milk sat undisturbed and chilled to 50° F. over night. The milk was heated to 105° F. by hot water (190° F.) jacket heating and mixing with the agitator. Calcium chloride (80g) was added and mixed into the milk for two minutes. 45 ml rennet (Chymax Extra Double strength from Chr. Hansen, Milwaukee, Wis.) was added into the milk with the agitator on for one minute. Agitation was stopped and rennet treatment was allowed to continue with the agitator off. The whole milk clotted and formed a continuous soft gel within four minutes, which was then broken/cut with a stirring paddle. The broken coagulum mixture of soft gel and whey was then pumped out with a positive displacement Sine pump (Model SPS-20, Konto Co. Inc, Orange, Mass.) at a rate of 2.2 gpm. Hot steam (80 psig) was directly injected into the pipe at the outlet of the Sine pump using a PICK heater device (PICK Sanitary Heater, model SC-2, West Bend, Wis.). The broken coagulum mixture was immediately heated to 160° F. by the steam injection. Heating of the broken/cut renneted coagulum mixture accelerated the syneresis of the whey and formed high-solids content curds.

The resulting curds/whey mixture flow (160° F.) was then cooled to 110° F. by passing through two 8-foot shell and tube cooling devices in which chilled water (43° F.) was flowing counter current in the outer jacket of the cooling device. The cooled curds/whey mixture (1 20° F.) was then fed into a Sweco separator (Sweco Separator, model LS305 66-30, Florence, Ky.) to separate the curds and whey. The separated curds were placed in a 50 gal. cheese vat and the curds pitched to drain. The curds were weighed, yielding 32 lbs. of curds. Salt (334 g) and citric acid (145 g) was added to the curds and thoroughly mixed by hand. Curds were placed in a cheese hoop and pressed for 30 minutes to expel the whey. After pressing, the cheese block (pressed curds) was vacuum packed in polyethelene film and vacuum sealed. The cheese block was placed in a 40° F. cooler for cooling. The proximate composition of the cheese block and whey was shown in Table 13.

TABLE 13

| | % Total | % | % | % | % | |
|---|---|---|---|---|---|---|
| | Solids | Protein | Ash | Fat | Lactose | pH |
| Cheese Curds | 59.56 | 25.14 | 2.96 | 29.0 | 1.45 | 5.14 |
| Separated Whey | 8.13 | 1.01 | 0.40 | 1.77 | 3.21 | 6.29 |

### EXAMPLE 9

Processed Cheese Made with Cheese Curds (pH 5.1) Obtained from Example 8

Processed cheese formulas containing the cheese curds from Example 8 in Formula 9A (50% replacement of conventional barrel cheese) and Formula 9B (100% replacement of conventional barrel cheese) were calculated and are shown in Table 14.

TABLE 14

| | Processed Cheese Formula | |
|---|---|---|
| | (lbs. per 10 lb cook) | |
| Cheese/Ingredient | Formula 9A | Formula 9B |
| Coventional Barrel cheese (15 day old) | 3.16 | 0 |
| Curds from Example 8 (15 days old) | 3.07 | 6.15 |
| Sodium citrate | 0.33 | 0.33 |
| Sorbic acid | 0.02 | 0.02 |
| Salt | 0.15 | 0.16 |
| NFDM | 0.64 | 0.57 |
| Conc. Milkfat (CMF) | 1.44 | 1.65 |
| Lactic Acid | 0 | 0 |
| Water | 1.50 | 1.13 |
| Total Weight | 10 | 10 |

Both formulas were targeted at the same finished product composition (39.8% moisture, 31.0% fat, 2.55% salt and 4.0%.lactose).

The cheese and ingredient blends (Formulas 9A & 9B) were cooked in a 10 lb. twin-screw Reitz cooker with indirect steam jacket heating at an auger speed setting of 86 rpm. The blend mixture was cooked to 175° F. for 10 minutes to form a homogenous molten plastic body, which was discharged from the cooker and collected into 14 ounce tubs for cooling (40° F., 3 days). The proximate composition, melt properties, and Instron firmness of the finished processed cheese are shown in Table 15.

TABLE 15

| | | Processed Cheese | | | | | | | |
|---|---|---|---|---|---|---|---|---|---|
| | | | | | | | | Firmness | |
| | | | | | | Meltability | | Instron | Instron |
| | | % | % | % | % | SFI | Mettler | Firmness | kg F/% |
| Formula | Cheese Type | Moist. | Fat | Protein | Salt | Melt | Melt (° F.) | (kg F) | protein |
| 9A | Conventional barrel | 38.47 | 32.0 | 18.01 | 2.74 | 4 | 157 | 2.882 | 0.160 |
| | cheese + cheese curds | | | | | | | | |
| | from Example 8 | | | | | | | | |
| 9B | Cheese curds from | 40.26 | 30.5 | 17.69 | 2.66 | 5 | 146 | 2.098 | 0.119 |
| | Example 8 only | | | | | | | | |

The finished processed cheeses (Formulas 9A and 9B) made with the cheese curds of this invention from Example 8 had acceptable flavor, body, and melt properties.

### EXAMPLE 10

Preparation of Cheese Curds (pH 6.2) from Cold Rennet-Treated Skim Milk

To prepare reconstituted skim milk, 180 lb of condensed skim milk (33.3% total solids, 12.1 % protein, 18.3% lactose and 2.53% ash) was diluted and mixed with 500 lb cold water (49° F.) in a 200 gallon milk tank with a 16″ agitating propeller blade operating at 94 rpm. The reconstituted skim milk was mixed with 270 ml of acetic acid (diluted 50% with water) to reduce the pH to 6.0. The acidified skim milk was kept cold at 40-45° F. and mixed with 30 ml rennet (Chymax Extra (2×), Chris Hansen, Milwaukee, Wis.) with continuous agitation overnight (about 18 hours). The rennet-treated skim milk had the proximate composition shown in Table 16.

TABLE 16

| | % Total | % | % | % | |
|---|---|---|---|---|---|
| | Solids | Protein | Lactose | Ash | pH |
| Rennet-treated | 8.81 | 3.20 | 4.87 | 0.67 | 6.0 |
| Skim Milk | | | | | |

Coagulum was never formed from the rennet-treated skim milk during the overnight cold rennet treatment at 40-45° F. The rennet-treated skim milk was then pumped out with a positive displacement Sine pump (Model SPS-20, Konto Co. Inc., Orange, Mass.) at a rate of 1.0 gpm. Hot steam (80 psig) was directly injected into the pipe at the outlet of the Sine pump, using a PICK heater device (PICK Sanitary Heater, model SC-2, West Bend, Wis.). The cold rennet-treated skim milk was thus immediately heated to 165° F. by the steam injection. Heating of the cold rennet-treated skim milk rapidly induced coagulation of the rennet-treated skim milk and simultaneous syneresis of the whey from the casein and formed high-solids content curds.

The resulting curds/whey mixture flow (160° F.) was then cooled to 120° F. by passing through two 8-foot shell and tube cooling devices in which chilled water (43° F.) was flowing counter-current in the outer jacket of the cooling device. The cooled curds/whey mixture (110° F.) was then fed into a Sweco separator (Sweco Separator, model LS 30S 66-30, Florence, Ky.) to separate the curds and whey. The separated curds cooled further in the Sweco separator to 105° F. and were then packed into 20 lb cheese hoops and lightly pressed to expel any free whey trapped in the curd matrix. The pressed skim curds (1 00° F.) were very finely ground in an Urschel grinder (model 3600, Urschel Laboratories, Valparaiso, Ind.) equipped with an Urschel type 3B-020035 cutting head. The proximate composition of the ground and composited skim curds, and the composite whey were as shown in Table 17.

TABLE 17

| | % Total | % | % | % | |
|---|---|---|---|---|---|
| | Solids | Protein | Lactose | Ash | pH |
| Skim curds | 42.02 | 36.42 | 2.32 | 4.04 | 6.22 |
| Separated whey | 6.05 | 0.78 | 4.76 | 0.49 | 6.20 |

Other examples of the present invention are contained in U.S. patent application Ser. No. 10/940,509, filed Sep. 13, 2004, and entitled “METHOD FOR FAST PRODUCTION OF CHEESE CURDS AND CHEESE PRODUCTS PRODUCED THEREFROM,” which is hereby incorporated by reference in its entirety.

The preferred embodiment of the invention has the advantage that skim milk can be rapidly processed into curds with less capital equipment and space requirements than traditional cheese manufacture or even rennet casein manufacture operations. For example, while a normal cheese making process may take 3-4 hours to make and separate the cheese curds, the curds of the present invention can preferably be made in less than ½ hour.

The preferred skim curds have an improved functional advantage compared to conventional full-fat barrel cheese protein.

The preferred process allows for an improved ability to optimize processed or imitation cheese formulation and finished product characteristics through individual selection of protein, fat, and ingredient sources. The casein can come from fluid milk or nonfat dry milk (NFDM), and the fat can come from previously separated milkfat or other fat sources. This translates into an economic benefit to processed or imitation cheese manufacture through procurement of lowest cost protein source for a skim curds production process (skim milk, condensed skim milk, re-hydrated nonfat dry milk, ultrafiltered skim milk, microfiltered skim milk, casein concentrates) and lowest cost fat source (cream, butter, concentrated milkfat, dry cream, vegetable oil, other animal fats).

The preferred process provides an ability to control calcium levels in skim curds via pH adjustment of the skim milk. As a result, this allows a manufacturer to target calcium levels in processed or imitation cheese products through pH control of the curd making process.

The preferred process does not have the problems sometimes encountered with rennet casein powder re-hydration or cook-up in processed or imitation cheese production. Further, compared to products made from rennet casein powder, the preferred products have improved flavor and odor.

One of the most important advantages of the preferred process is that it provides on-demand manufacture of highly-functional protein (from a variety of re-hydrated skim milk powders). This is a significant advantage in many parts of the world.

On the other hand, if the cheese curds are not used immediately, they can be stored without aging and becoming softer, as happens with traditional curds, because the enzyme and any cultures are deactivated by the high-temperature heating step of the present invention. This simplifies the complexities caused by the amount of time cheese ages before it is used to make processed cheese. In this regard, it is believed that a cheese product having a composition and texture like that of an American-type cheese, made with a milk coagulating enzyme which has become predominantly deactivated during the make process, is novel. Such a novel product includes an acidifying agent other than lactic acid, which provides the product with a pH of between about 4.9 and about 5.6.

An increased firmness in processed cheese has numerous benefits. A firmer product can be packaged at higher rates of speed. Manufacturing steps are also easier to perform when the processed cheese is firm. The packaged product maintains its shape, resisting cold flow. The preferred embodiment of the present invention provides a mechanism whereby the firmness of the processed cheese can be improved while significantly reducing the time required to make the processed cheese, and while maintaining acceptable melt properties.

Preferably the processed cheese will have a ratio of Instron firmness to protein content percentage of at least 0.075 kg F/% protein. Compared to a processed cheese with an identical composition made with conventional cheese curds, the processed cheese of the present invention will preferably have an increased Instron firmness of at least 25%, more preferably at least 35%, even more preferably at least 50%, and most preferably at least 100%.

It should be appreciated that the methods and products of the present invention are capable of being incorporated in the form of a variety of embodiments, only a few of which have been illustrated and described above. The invention may be embodied in other forms without departing from its spirit or essential characteristics. All of the preferred embodiments relate to any or all of the independently claimed processes and products, taken either singly or in combination.

The described embodiments are thus to be considered in all respects only as illustrative and not restrictive, and the scope of the invention is, therefore, indicated by the appended claims rather than by the foregoing description. All changes that come within the meaning and range of equivalency of the claims are to be embraced within their scope.

We Claim:

1. A method of making cheese curds comprising the steps of:
a) providing a fluid milk protein source containing casein;
b) mixing a milk coagulating enzyme into the fluid milk protein source;
c) allowing the milk coagulating enzyme to react with the casein for a time sufficient for the fluid milk protein source to form coagulum while at a pH of 5.6 or above;
d) heating the coagulum containing the enzyme treated casein to a temperature of at least 150° F. while the fluid milk protein source is at a pH of 5.6 or above, for a time sufficient to cause syneresis of the coagulum and to form curds; and
e) separating the curds from liquid remaining from the curd formation.

2. The method of claim 1 wherein the fluid milk protein source containing casein is selected from the group consisting of skim milk, part skim milk, whole milk, reconstituted milk, condensed milk, ultrafiltered milk, reverse osmosis milk, microfiltered milk and mixtures thereof.

3. The method of claim 1 wherein the fluid milk protein source containing casein comprises skim milk.

4. The method of claim 1 wherein the fluid milk protein source containing casein comprises whole milk.

5. The method of claim 1 wherein the fluid milk protein source containing casein has a fat content of greater than 0.5%.

6. The method of claim 1 wherein the remaining liquid comprises whey proteins.

7. The method of claim 1 wherein the fluid milk protein source containing casein is pasteurized prior to mixing in of the milk coagulating enzyme.

8. The method of claim 1 wherein the milk coagulating enzyme is selected from the group consisting of calf rennet, porcine rennet, microbial rennet and rennet from fungal and vegetable sources.

9. The method of claim 1 wherein the fluid containing the enzyme treated casein is heated by direct steam injection.

10. The method of claim 1 wherein the curds begin to be separated from the remaining liquid within a period of less than 1 minute from when the fluid containing the enzyme treated casein begins to be heated.

11. The method of claim 1 wherein the fluid milk protein source containing casein has a casein concentration of less than 4%.

12. The method of claim 1 wherein the fluid milk protein source containing casein has its pH adjusted to between 5.6 and about 6.2 prior to the mixing in of the milk coagulating enzyme.

13. The method of claim 1 wherein the fluid milk protein source containing casein is provided by pasteurizing milk and cooling the pasteurized milk to a temperature of between about 40° F. and about 120° F. prior to mixing with the milk coagulating enzyme.

14. The method of claim 1 wherein the fluid milk protein source containing casein is provided by pasteurizing milk and cooling the pasteurized milk to a temperature of between about 80° F. and about 115° F. prior to mixing with the milk coagulating enzyme.

15. The method of claim 1 wherein a source of calcium is added to the fluid milk protein source containing casein before the coagulum is formed.

16. The method of claim 15 wherein said calcium source comprises calcium chloride.

17. The method of claim 1 wherein the fluid milk protein source contains casein and whey proteins at a ratio of casein to whey proteins of greater than 10:1.

18. The method of claim 1 wherein the coagulum is heated to a temperature of between about 150° F. and about 200° F.

19. The method of claim 1 wherein the coagulum is heated to a temperature of between about 150° F. and about 180° F.

20. The method of claim 15 wherein the source of calcium is added to the fluid milk protein source containing casein before the milk coagulating enzyme is mixed in.

21. The method of claim 1 wherein the curds are separated from the remaining liquid using a method selected from the group consisting of centrifugal separation, vibratory screening, pressing, vacuum separation and combinations thereof.

22. The method of claim 1 wherein the curds and remaining liquid are cooled to a temperature of less than about 120° F. prior to separation.

23. The method of claim 1 wherein the curds and remaining liquid are cooled to a temperature of between about 40° F. about 90° F. prior to separation.

24. The method of claim 1 wherein the step of heating the coagulum is carried out in a continuous flow process.

25. The method of claim 1 wherein the milk coagulating enzyme is allowed to react with the casein before it is heated for a period of between about 2 minutes and about 90 minutes.

26. The method of claim 1 wherein the fluid milk protein source has a pH of between about 5.6 and about 6.2 and the enzyme is allowed to react with the casein before it is heated for a period of between about 2 minutes and about 30 minutes.

27. The method of claim 1 wherein the fluid milk protein source has a pH of between about 6.2 and about 6.7 and the enzyme is allowed to react with the casein before it is heated for a period of between about 5 minutes and about 60 minutes.

28. The method of claim 1 wherein the milk coagulating enzyme is allowed to react with the casein under quiescent conditions.

29. The method of claim 1 wherein the coagulum is broken before being heated.

30. Curds made by the method of claim 1.

31. Skim milk curds made by the method of claim 3 wherein the skim milk curds have a solids content of between about 30% and about 50%, a protein content of between about 24% and about 42%, a fat content of less than 1%, and a lactose content of at least 1.5%.

32. A method of making a cheese product comprising the steps of:
a) providing a fluid milk protein source containing casein;
b) mixing a milk coagulating enzyme into the fluid milk protein source;
c) allowing the milk coagulating enzyme to react with the casein for a time sufficient for the fluid milk protein source to form coagulum while at a pH of 5.6 or above;
d) heating the coagulum containing the enzyme treated casein to a temperature of at least 150° F. while the fluid milk protein source is at a pH of 5.6 or above, for a time sufficient to cause syneresis of the coagulum and to form curds;
e) separating the curds from liquid remaining from the curd formation; and
f) mixing the curds with additional ingredients to make the cheese product.

33. The method of claim 32 wherein the cheese curds are made into processed cheese.

34. The method of claim 32 wherein the cheese curds are made into imitation cheese.

35. The method of claim 32 wherein the cheese curds are made into a processed cheese having a composition functionally and compositionally comparable to a processed cheese selected from the group consisting of pasteurized process cheese, pasteurized process cheese food, pasteurized process cheese spread and pasteurized process cheese product.

36. The method of claim 32 wherein the cheese curds are made into a processed cheese having a composition comprising from about 39% to about 40% moisture, from about 30% to about 33% fat, from about 17% to about 19% protein and from about 2% to about 2.5 % salt.

37. The method of claim 32 wherein the cheese curds are made into a processed cheese having a composition required of pasteurized process American cheese.

38. The method of claim 32 wherein the additional ingredients comprise an emulsifying agent.

39. The method of claim 38 wherein the emulsifying agent is selected from the group consisting of monosodium phosphate, disodium phosphate, dipotassium phosphate, trisodium phosphate, sodium metaphosphate, sodium acid pyrophosphate, tetrasodium pyrophosphate, sodium aluminum phosphate, sodium citrate, potassium citrate, calcium citrate, sodium tartrate, sodium potassium tartrate and mixtures thereof.

40. The method of claim 38 wherein the emulsifying agent comprises sodium citrate.

41. The method of claim 32 wherein the curds are mixed with sodium chloride and packed into a form.

42. The method of claim 41 wherein the formed cheese is cut into customer-size cut portions and sold in their cut form.

43. The method of claim 32 wherein the curds are ground to have a weight average particle size of about 1.5 mm or less and then used to make the cheese product.

44. The method of claim 32 wherein the fluid milk protein source containing casein comprises skim milk and the additional ingredients comprise milkfat and sodium chloride.

45. The method of claim 32 wherein the additional ingredients comprise an acidifying agent.

46. The method of claim 45 wherein the acidifying agent comprises citric acid.

47. The method of claim 32 wherein the curds are used to make the cheese product within less than two hours after the milk coagulating enzyme is mixed with the fluid milk protein source.

48. The method of claim 32 wherein the coagulum is cut and heated in a continuous flow heating operation, and the cheese product is made within less than 1.5 minutes/1000 pounds of heated coagulum after the coagulum is cut.

49. A processed cheese made by the method of claim 33.

50. The processed cheese of claim 49 having a ratio of Instron firmness to protein content percentage of at least 0.075 kg F/% protein.

51. The processed cheese of claim 49 having an increased Instron firmness of at least 25% compared to a processed cheese with an identical composition made with conventional cheese curds and the same process.

52. The processed cheese of claim 49 having an increased Instron firmness of at least 35% compared to a processed cheese with an identical composition made with conventional cheese curds and the same process.

53. The processed cheese of claim 49 having an increased Instron firmness of at least 50% compared to a processed cheese with an identical composition made with conventional cheese curds and the same process.

54. The processed cheese of claim 49 having an increased Instron firmness of at least 100% compared to a processed cheese with an identical composition made with conventional cheese curds and the same process.

55. Ground cheese curds having a weight average particle size of about 1.5 mm or less.

56. The ground cheese curds of claim 55 further comprising an emulsifying agent.

57. The ground cheese curds of claim 56 wherein the emulsifying agent comprises sodium citrate mixed with the curds at a ratio of between about 100:1 and about 100:15 curds: sodium citrate.

58. The ground cheese curds of claim 56 wherein the emulsifying agent comprises sodium citrate mixed with the curds at a ratio of between about 100:2 and about 100:10 curds: sodium citrate.

59. A composition consisting essentially of a fluid milk protein source containing casein and milk coagulating enzyme in the form of a coagulum at a temperature of at least about 160° F.

60. The composition of claim 59 having a temperature of between about 160° F. and about 200° F.

61. A method of heating a fluid containing a coagulum of casein proteins wherein the fluid is heated at a rate of at least 110° F./sec. and to a temperature of at least 135° F. at least in part by direct injection of steam into the fluid while the fluid is continuously flowing.

62. A method of making cheese curds comprising the steps of:
a) providing a fluid milk protein source containing casein;
b) mixing a milk coagulating enzyme into the fluid milk protein source;
c) allowing the milk coagulating enzyme to react with the casein for at least three hours while at a temperature at which a coagulum does not form;
d) heating the fluid milk protein source containing the enzyme treated casein to a temperature of at least 135° F. for a time sufficient to cause the casein to form curds; and
e) separating the curds from liquid remaining from the curd formation.

63. The method of claim 62 wherein the fluid milk protein source containing casein has its pH adjusted to between about 5.6 and about 6.2 prior to the mixing in of the milk coagulating enzyme.

64. The method of claim 63 wherein the fluid milk protein source containing casein and mixed milk coagulating enzyme are held for a period of at least six hours before the fluid is heated.

65. The method of claim 62 wherein the fluid milk protein source containing casein and mixed milk coagulating enzyme are held at a temperature of less than about 50° F.

66. A cheese product having a composition and texture like that of an American-type cheese, made with a milk coagulating enzyme which has become predominantly deactivated during the make process, and including an acidifying agent other than lactic acid which provides the product with a pH of between about 4.9 and about 5.6.

67. A method of making processed cheese comprising the steps of:
a) providing skim milk curds;
b) grinding the skim milk curds;
c) pretreating the ground skim milk curds with an emulsifying agent to form pretreated ground skim curds;
d) combining the pretreated ground skim curds with additional ingredients; and
e) cooking the pretreated ground skim curds and additional ingredients to make processed cheese.

68. The method of claim 67 in which the skim milk curds are ground to a weight average particle size of about 1.5 mm or less before being pretreated with the emulsifying agent.

69. The method of claim 67 in which the pretreated ground skim curds are stored for at least 12 hours before they are made into processed cheese.

70. The method of claim 67 in which the composition of the pretreated ground skim curds comprises over 10% emulsifying agent by weight of the protein.

71. The method of claim 67 wherein the additional ingredients comprise an additional emulsifying agent.

72. The method of claim 67 wherein the additional ingredients are mixed with the pretreated ground skim curds in a processed cheese cooker.

73. The method of claim 67 wherein only skim milk curds and emulsifying agent are mixed together in the pretreatment step.

74. The method of claim 8 wherein the milk coagulating enzyme comprises fermentation derived chymosin.

75. A method of making cheese curds comprising the steps of:
a) providing milk containing casein and having a solids content of between about 7% and about 25%;
b) adjusting the pH of the milk to between about 5.8 and about 6.4;
c) mixing a milk coagulating enzyme into the milk in a cheese making vat;
d) allowing the milk coagulating enzyme to react with the casein for a time sufficient to cause a coagulum to form in the cheese making vat;
e) cutting the coagulum while in the cheese making vat, said cutting occurring not more than 10 minutes after the milk coagulating enzyme is mixed with the milk;
f) heating and stirring the cut coagulum in the cheese making vat to a temperature of at least 135° F. for a time sufficient to cause syneresis and the coagulum to form curds; and
g) separating the curds from whey resulting from the curd formation process;
h) the heating occurring over a period of not greater than 20 minutes, the duration of the heating period being measured from the time beginning when the cut coagulum begins to be stirred and its temperature is elevated, and ending when the whey starts to be separated.

76. The method of claim 75 wherein the curds begin to be separated from the liquid remaining from the curd formation process within about 10 minutes or less after the fluid milk protein source containing the enzyme treated casein begins to be heated.

77. A method of making a processed cheese product comprising the steps of:
a) providing a fluid milk protein source containing casein;
b) allowing the milk coagulating enzyme to react with the casein for a time sufficient for the fluid milk protein source to form coagulum while at a pH of 5.6 or above;
d) heating the coagulum containing the enzyme treated casein to a temperature of at least 135° F. while the fluid milk protein source is at a pH of 5.6 or above, for a time sufficient to cause syneresis of the coagulum and to form curds;
e) separating the curds from liquid remaining from the curd formation; and
f) mixing the curds with additional ingredients to make the processed cheese product, wherein the curds are either
i) used to make the processed cheese within 24 hours of being separated from the remaining liquid or
ii) mixed with an acidifying agent and stored for at least 24 hours before being used to make the processed cheese.

78. The method of claim 1 wherein the cheese curds are dried to a moisture content of 12% or less after the liquid is separated.

79. The method of claim 32 wherein the cheese curds are made into a cheese sauce.

80. The method of claim 1 wherein the fluid containing the enzyme treated casein is heated by conductive surface heating.

81. The method of claim 32 wherein the additional ingredients comprise conventional cheese.

82. The method of claim 77 wherein no lactic acid bacterial starter culture is used during the process of making the processed cheese product from the fluid milk protein source.
